(19) United States
(12) Patent Application Publication
(10) Pub. No.: US 2008/0037611 A1
(43) Pub. Date: Feb. 14, 2008

(54) DYNAMIC OPTIMISATION OF BLOCK TRANSMISSIONS FOR INTERFERENCE AVOIDANCE

(75) Inventor: Justin COON, Bristol (GB)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/838,151

(22) Filed: Aug. 13, 2007

(30) Foreign Application Priority Data
Aug. 11, 2006 (GB) 0616047.7

(51) Int. Cl. H04B 1/02

(52) U.S. Cl. 375/145; 375/E01.001

(57) ABSTRACT

A signal transmission system shapes the spectrum of a signal in a block transmission system by applying an envelope function, the shaping means comprising:
means for optimising the envelope function under one or more constraints selected from a set of predetermined constraints; and
means for applying the optimised envelope function to the signal,
   wherein the means for optimising the envelope function is operable to employ a quasi-Newton optimisation of reduced complexity in comparison with the classical Newton optimisation technique, for reduced computation in real time.

The present invention relates to a method of spectral shaping of a signal. More particularly it relates to a method of spectral shaping which may be used for interference avoidance in a dynamic manner, and the corresponding signal transmission system and receiver.

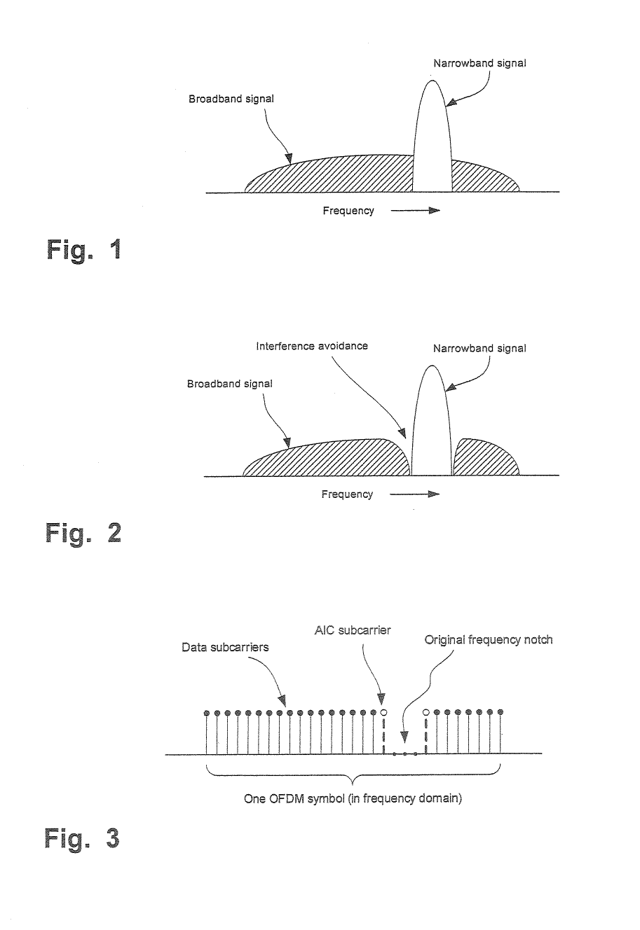

Spectral shaping for narrowband interference avoidance is an important part in cognitive radio, and is essential in ultra wideband (UWB) communication systems. With reference to FIG. 1, which illustrates an example of a narrowband and a broadband signal occupying overlapping bandwidth in the frequency domain, the problem typically occurs when a broadband user's signal collides with a narrowband user's signal in the frequency spectrum, thus resulting in degradation in performance for the two communication links.

It has been proposed that, in some applications, the broadband user should modify his signal such that little or no energy is transmitted on the frequencies on which the narrowband user's signal resides. FIG. 2 illustrates this ‘interference avoidance’ (IA) technique in an example of a narrowband and a broadband signal, where interference avoidance provides some separation of users' signals in the frequency domain such that, with the possible aid of signal processing, both communication links do not significantly suffer from multi-user interference.

Interference avoidance is especially important in UWB communications, since UVB systems utilise a very broad bandwidth for low-power transmission, which makes interference with narrowband users virtually unavoidable. This problem is exacerbated by the fact that UWB devices are unlicensed (i.e. operators do not pay for licenses), whereas the devices with which they interfere are licensed. Obviously, priority should be given to licensed users in these scenarios; in this case, interference avoidance should be applied at the transmitter of the UWB device.

Some work has been carried out on the subject of interference avoidance. Common methods of implementing interference avoidance include transmit power control, frequency notching, and active interference cancellation.

Transmit power control (TPC) is based on the principle of transmitting data using the minimum amount of power that is required. Of course, the drawback of this technique is that the device that implements TPC attenuates its entire signal, which may lead to catastrophic performance in extreme cases (i.e. little or no information is conveyed).

Frequency notching involves nulling a transmitted signal on localised portions of bandwidth. Frequency notching can be achieved through simple analogue notch filters, although it is difficult and usually impractical to design tuneable notch filters for dynamically creating nulls (notches) with varying widths and centre frequencies. Dynamic frequency notching may arise in many scenarios, such as when a broadband device shares its bandwidth with a slow-frequency-hopping spread-spectrum transmission, A more practical solution to dynamic frequency notching can be realised in block transmission systems, such as cyclic-prefixed single-carrier and OFDM systems, through the use of a fast Fourier transform (FFT). In particular, frequency notches can be dynamically designed by inserting zeroes at the appropriate pins in the (inverse) FFT. Unfortunately, the depths of the frequency notches in practice are somewhat limited due to the upsampling of the signal. Consequently, even if a discrete, symbol-spaced signal is designed to have perfect (infinitely deep) frequency notches, once this signal is upsampled, these notches can be as shallow as only −9 dB.

An active interference cancellation (AIC) technique for multi-band OFDM cognitive radio has been proposed by H. Yamaguchi in: “Active interference cancellation technique for MB-OFDM cognitive radio,” 34th European Microwave Conference, vol. 2, 2004, and in US Patent Application US2006/008016 (on which Yamaguchi is named as an inventor).

Active interference cancellation is a form of frequency notching used in OFDM systems whereby additional frequency tones are allocated at either side of the original notch for interference cancellation. FIG. 3 depicts an example of the distribution of data subcarriers for one OFDM symbol in the frequency domain. In addition to the nulled subcarriers creating the original frequency notch, the two neighbouring AIC subcarriers are likewise modified. In this context, the term ‘interference cancellation’ refers to the nulling of any additional signal energy that resides in the desired frequency notch when the signal is upsampled. This technique can achieve deeper notches in the transmit spectrum than conventional frequency notching for both single-carrier and multi-carrier block transmission systems. However, AIC suffers from two major drawbacks:

1. Like frequency notching, data must be nulled, or punctured, in order to avoid interfering with narrowband signals. In variable-length transmissions, this issue is not a large problem, although it does mean that any nulled data must be transmitted using additional channel resources. If additional OFDM symbols are required to transmit the punctured data, the data rate may be considerably reduced. In fixed-length transmissions, however, this drawback is crucial since any punctured data is lost. In this case, the performance of a system degrades even for narrow frequency notches.

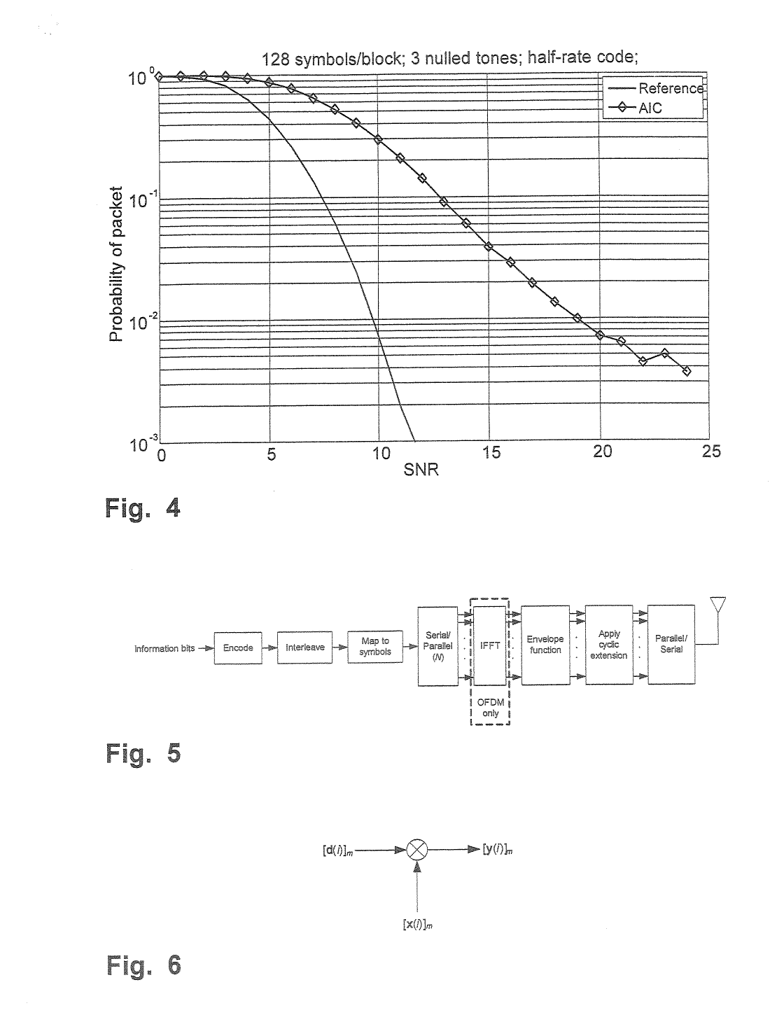

2. Since AIC is implemented in the frequency domain, it is not able to be effectively adapted to single-carrier systems. In fact, the perturbation of the frequency-domain signal in a single-carrier system leads to very poor performance, even with a strong error correction code (ECC) and robust modulation. This is shown in FIG. 4, which depicts the probability of packet error versus the signal-to-noise ratio (SNR) for 128 symbols per block with three nulled tones and a half-rate convolutional code.

Narrowband interference avoidance in ultra wideband communication systems has been discussed by P. Yaddanapudi and D. Popescu in: “Narrowband interference avoidance in ultra wideband communication systems,” IEEE Global Telecommunications Conference (GLOBECOM), 2005.

In US 2005/0232336 A1 (Balakrishnan et al.), a system for signal shaping in ultra-wideband communications by spectral shaping in the frequency domain is disclosed. The systems described above have a number of drawbacks and inconveniences. Systems that implement TPC to perform interference avoidance cannot, by definition, transmit at full power; thus a loss in information rate is unavoidable. Conventional frequency notching can realistically provide notches on the order of approximately only −9 dB. Finally, while active interference cancellation works well in multi-carrier systems with a variable transmission length, when applied to fixed transmission length systems and (especially) single-carrier systems, the performance of a system using this technique degrades significantly.

UK Patent Application 0606687.2 provides an approach described herein as Numerical dynamically optimised IA. Numerical and iterative optimisation techniques can be performed to ensure that a block transmission signal is not transmitted on a predetermined range of frequencies. This optimisation is carried out such that a real-valued envelope is applied to each data block where the power and amplitude of the envelope can be constrained to facilitate blind detection at the receiver. Interior point methods are well-suited to this optimisation problem, and Newton's method, when used in conjunction with an interior point method, gives particularly good results.

This observed performance of Newton's method is largely due to the fact that the algorithm utilises second order information about the original objective function (the function to be minimised/maximised) and constraint functions with each iteration to choose the best ‘search direction’ with which the optimisation variable (the envelope function in this case) is updated. Unfortunately, the exploitation of second order information requires that a potentially large linear system be solved, which can be prohibitively complex when done often. To solve this problem, variants of Newton's method have been proposed. The quasi-Newton method, for example, does not solve this linear system directly, but instead builds an approximation of the solution over time. Of course, this approach relies on a large number of iterations to carry out the approximation, which can also lead to computational problems. Alternatively, a modified Newton method has been proposed where the system is solved only once at the start of the algorithm Consequently, a good initial update is made to the optimisation variable, but future updates rely mostly on first order information. This modified Newton method can be complex as well since the linear system must still be solved once per execution of the algorithm.

In general terms, an aspect of the invention provides a reduced-complexity method of achieving spectral shaping, and in particular IA, that is built on the numerical technique discussed above.

Aspects of the present invention are suitable for application in any wireless or wired communication devices that use block transmissions (e.g. cyclic-prefixed single-carrier transmissions, OFDM) where interference avoidance is desired. Example devices in the current market include UWB-equipped PDAs, cameras, laptops, etc.

One aspect of the invention provides a method of shaping the spectrum of a signal in a block transmission system by applying an envelope function, the method comprising:
optimising the envelope function under one or more constraints selected from a set of predetermined constraints; and
applying the optimised envelope function to the signal,
   wherein the step of optimising the envelope function comprises employing a quasi-Newton optimisation involving determination of an approximate inverse ∇²\tilde{f}(y)⁻¹ of an objective Hessian matrix of a cost function y of the optimisation, said approximate inverse comprising

$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} {yy}^{T} {\tilde{B}}^{- 1}$$

$$wherein$$

$${\tilde{B}}^{- 1} = \frac{1}{t} {{D}^{- 1} ( Ω + \frac{γ}{{σ}_{d}^{2}} I )}^{- 1} {D}^{- 1} ,$$

### D being a diagonal data matrix, and Ω:=W^{H}W+(W^{H}W)^{T}, W being a domain transform matrix, γ being a design factor, and σ_{d}² being the variance of the zero mean data signal.

Another aspect of the invention provides a signal transmission system comprising means for shaping the spectrum of a signal in a block transmission system by applying an envelope function, the shaping means comprising:
means for optimising the envelope function under one or more constraints selected from a set of predetermined constraints; and
means for applying the optimised envelope function to the signal,
   wherein the means for optimising the envelope function is operable to employ a quasi-Newton optimisation involving determination of an approximate inverse ∇²\tilde{f}(y)⁻¹ of an objective Hessian matrix of a cost function y of the optimisation, said approximate inverse comprising

$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} {yy}^{T} {\tilde{B}}^{- 1}$$

$$wherein$$

$${\tilde{B}}^{- 1} = \frac{1}{t} {{D}^{- 1} ( Ω + \frac{γ}{{σ}_{d}^{2}} I )}^{- 1} {D}^{- 1} ,$$

### D being a diagonal data matrix,

and Ω:=W^{H}W+(W^{H}W)^{T}, W being a domain transform matrix, γ being a design factor, and σ_{d}² being the variance of the zero mean data signal.

These and other aspects of the invention will now be further described, by way of example only, with reference to the accompanying figures in which:

FIG. 1 illustrates an example of a narrowband a broadband signal occupying overlapping bandwidth in the frequency domain.

FIG. 2 illustrates an example of narrowband interference avoidance in the frequency domain.

FIG. 3 illustrates the distribution of AIC subcarriers and OFDM symbol structure in the frequency domain.

FIG. 4 shows the performance of a cyclic-prefixed single-carrier system using AIC.

FIG. 5 shows a block diagram of a baseband transmitter structure according to the invention.

FIG. 6 illustrates the envelope function processing.

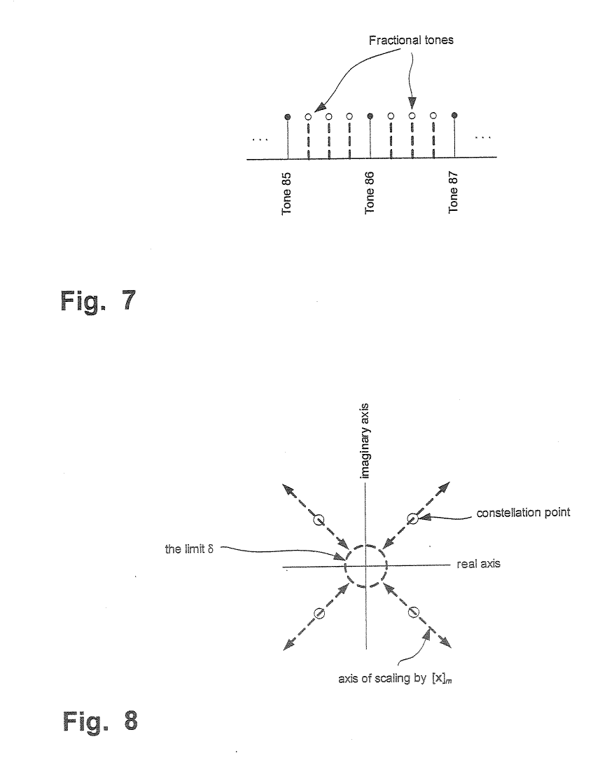

FIG. 7 illustrates an example of the fractional tones in dynamically optimised interference avoidance.

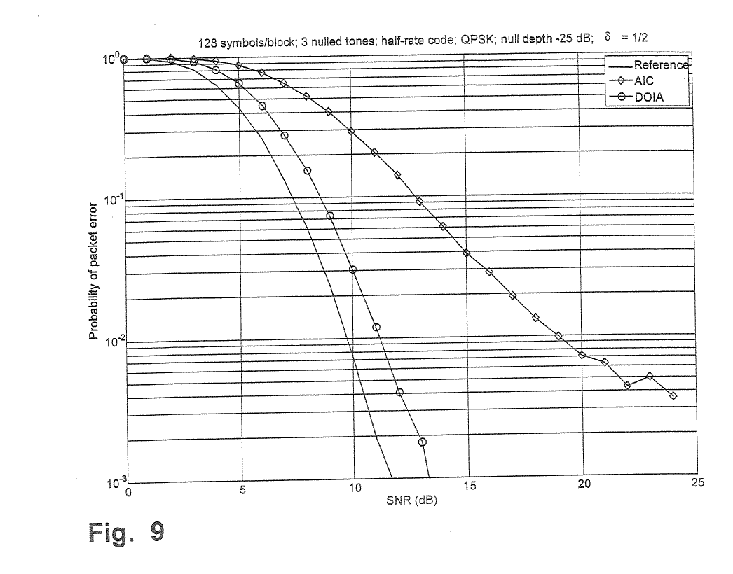

FIG. 8 illustrates an example of envelope scaling for a constant modulus constellation (QPSK).

FIG. 9 shows the packet error rate vs. SNR for three single-carrier block transmission systems: a reference system; one employing AIC; and one employing the proposed dynamically optimised interference avoidance invention.

A method of shaping the spectrum of a signal in a block transmission system by applying a time-domain envelope function is disclosed. In the following description, a number of specific details are presented in order to provide a thorough understanding of embodiments of the present invention. It will be apparent, however, to a person skilled in the art that these specific details need not be employed to practice the present invention.

The process of applying an envelope to a transmitted signal in the time-domain for spectral shaping can be implemented in the analogue domain or the digital domain. The optimisation process detailed below is performed in the digital domain; however, it will be understood that similar analogue-domain techniques may be applied with a similar outcome.

The basic processing that is required at the transmitter is depicted in FIG. 5. I this figure, it is observed that a stream of bits is (optionally) encoded, interleaved, and mapped to complex baseband constellation symbols such as M-PSK or M-QAM where M is the size of the alphabet. The resulting constellation symbols are partitioned into blocks of length N. If this is a multi-carrier system such as OFDM, each block is then processed with an I-point inverse FFT (IFFT). Otherwise, if the system utilises conventional single-carrier modulation, no IFFT is performed. Finally, each block of time-domain data symbols is perturbed with an envelope function prior to further processing and/or transmission.

By way of background, it is convenient to begin with a discussion of the envelope function previously described in 0606687.2 that will be used for shaping the spectrum of the signal in the time-domain. The ith original block of data symbols (prior to the application of the envelope function) is denoted by the length-N column vector d(i). The processing that is performed by the envelope function is a simple scaling of each element of d(i) by a (possibly) complex-valued coefficient. This process is depicted in FIG. 6 where [a]ₘ denotes the mth element of the vector a, x(i) is the ith length-N column vector of envelope coefficients, and y(i) is the ith length-N column vector of symbols at the output of the envelope function. The key is to design the vector x(i) such that some spectral shaping criterion (or criteria) is satisfied. This design can be performed by formulating a cost (or utility) function f₀(x(i)) that is to be minimised (maximised).

minimise/maximise f₀(x(i))

subject to some constraints

In the case of interference avoidance, this cost function should logically define the amount of energy that is transmitted on a given set of frequencies, where the objective is to minimise this energy.

The skilled person will appreciate that this energy should be defined for a set of frequencies after upsampling so as to avoid the problems that are encountered with simple frequency notching. A typical upsampling frequency might be four times the symbol-spaced sampling frequency, although any suitable faster or slower sampling rate may be used.

The general dynamic interference avoidance problem can be formulated mathematically. Accordingly, x(i) can be designed for dynamic interference avoidance as follows. Omitting the block index i without loss of generality, let D=diag {d}, and let WεC^{Q×N} (where C denotes the set of complex numbers) be the Q rows of the uN×N upsampled discrete Fourier transform matrix where u is the upsampling factor (e.g. u=4). For example, if it were desired that tones 85, 86, and 87 were to be nulled using an upsampling factor of u=4, then W would be a 9-by-N matrix since there are three fractional samples between 85 and 86, and there are three more fractional samples between 86 and 87 (FIG. 7). The minimisation problem can now be formulated as

minimise f₀(x)=∥WDx∥₂²

subject to some constraints

where ∥·∥₂ denotes the l₂-norm.

In order to solve the problem it may be necessary to add constraints to be observed when optimising. Depending on the nature of the constraints, this problem can be solved analytically or numerically. If a constraint were placed on the total power of the signal at the output of the envelope function, the problem could be formulated as

minimise f₀(x)=∥WDx∥₂²

subject to ∥Dx∥₂²=N

which can be solved analytically for the case where the envelope vector x is real-valued or complex-valued. In both cases, the optimal x simply lies in the null space of WD (and is normalised such that the constraint is true). As long as Q<N (i.e. W is a ‘fat’ matrix), the null space of WD will be non-empty. Otherwise, if Q≧N, the null space of WD is empty and x will not perfectly remove the energy from the interference tones, but it will minimise this energy as long as it is chosen to be the eigenvector corresponding to the smallest eigenvalue of the generalised eigenvalue problem:

D^{H}W^{H}WDx=λD^{H}Dx(complex-valued x)

[symbol]

{D^{H}W^{H}WD}x=λD^{H}Dx_{(real-valued x)}

Unfortunately, this solution requires that the receiver know what x was defined as during transmission. Of course, this information can be conveyed to the receiver by computing x(i+1) and including this information in y(i)=D(i) x(i). Obviously, this approach requires a high amount of overhead and buffering of data (at either the transmitter or the receiver) so that the receiver can recover the vector x(i) in order to be able to detect d(i). For this reason, this technique may in some cases be undesirable for some applications.

In practical situations, the receiver may not have knowledge of x. An additional constraint can therefore be added to the original interference avoidance problem, which allows the receiver to perform detection and decoding without having knowledge of x. In particular, the elements of x can be constrained to be real-valued and greater than or equal to some positive number δ. Furthermore, as shown in FIG. 8, if the constellation scheme is limited to being a member of the set of constant-modulus constellations (e.g. BPSK, QPSK, 8-PSK), a simple positive scaling of each data symbol would allow the receiver to distinguish between constellation points without knowledge of x. Under these constraints, the problem can be formulated as

$$minimise {f}_{0} ( x ) = {‖ WDx ‖}_{2}^{2}$$

$$subject to {‖ Dx ‖}_{2}^{2} = {‖ x ‖}_{2}^{2} = {N \\ [ x ]}_{m} \geq δ , ∀ m$$

In this case, the problem cannot in general be solved analytically. However, numerical nonlinear optimisation methods can be employed. These techniques include gradient descent methods, the method of steepest descent, Newton's method, and interior point methods (including the barrier method and the primal dual method). In particular, interior point methods excel when inequality constraints are present in the optimisation problem.

The interior point method known as the barrier method is particularly suited to the constrained minimisation problem stated above. The barrier method is summarised in Table 1:

TABLE 1
Summary of the barrier method (Boyd, S. and Vandenberghe, L.,
Convex Optimization, Cambridge University Press. 2004).

given strictly feasible x, t > 0, μ > 1, εₒ > 0, εᵢ > 0
repeat
1. Newton's method (x, εᵢ > 0)

| | |
|---|---|
| a. | Δx = −∇²f (x)⁻¹ ∇f (x) |
| | λ² = −∇f (x)^{H} Δx |
| b. | quit if λ²/2 < εᵢ |
| | return x* := x |
| c. | line search (determine β) |
| d. | x := x + βΔx |

```
    2. x := x*
    3. quit if p/t < εₒ
    4. t := μt
```

The parameters outlined in this table will be discussed in more detail below. In order to implement the barrier method to solve the aforementioned optimisation problem, the quadratic equality constraint must be eliminated in some way. This requirement is a fundamental issue with the barrier method, which does not support nonlinear equality constraints. One simple method of eliminating the equality constraint is to add a small tolerance ε0 to the norm constraint and replace the equality with a box inequality, which results in the modified but similar problem given by

minimise f₀(x)=∥WDx∥₂²

subject to N−ε≦∥x₂²≦N+ε

[x]ₘ≧δ,∀m

The constraints of this problem are rewritten in a standard form, thus giving

minimise f₀(x)=∥WDx∥₂²

subject to f₁(x)=N−ε−∥x∥₂²≦0

f₂(x)=∥x∥₂²−N−ε≦0

fₘ₊₂(x)=δ−[x]ₘ≦0

In the barrier method, inequality constraints are added to the cost (or utility) function by defining a logarithmic barrier constraint function for each inequality constraint. In this case, there are p=N+2 logarithmic barrier constraints, given by

$${g}_{1} ( x ) = - \frac{1}{t} log ( - {f}_{1} ( x ) ) = - \frac{1}{t} log ( {‖ x ‖}_{2}^{2} - N + ɛ )$$

$${g}_{2} ( x ) = - \frac{1}{t} log ( - {f}_{2} ( x ) ) = - \frac{1}{t} log ( N + ɛ - {‖ x ‖}_{2}^{2} )$$

$${g}_{m + 2} ( x ) = - \frac{1}{t} log ( - {f}_{m + 2} ( x ) ) = - \frac{1}{t} log ( {e}_{m}^{T} x - δ )$$

where eₘ^{T} is the mth length-N unit vector and the parameter t is the logarithmic barrier accuracy parameter, which is incremented with each outer iteration of the barrier method as outlined in Table 1. The purpose of the logarithmic constraint functions is to quantify the ‘displeasure’ or ‘undesirability’ of not satisfying the former inequality constraints. As the arguments of the logarithmic constraint functions approach zero (from below), the values of the functions approach infinity. Thus, these logarithmic constraint functions can be incorporated into the cost function to give a composite cost function. The new composite cost function is given by

f(x)=tf₀(x)+tΣgₖ(x)=tf₀(x)−Σ log(−fₖ(x))

where the multiplication by t does not alter the optimisation problem.

As outlined in Table 1, the first and second derivatives (gradients and Hessians) of the composite cost function—and thus the original cost function and the logarithmic constraint functions—must be computed. These derivatives are given below.

### Gradients:

$$∇ {f}_{0} ( x ) = ( {D}^{H} {W}^{H} W D + {( {D}^{H} {W}^{H} W D )}^{T} ) x$$

$$∇ {g}_{1} ( x ) = \frac{2}{t ( N - ɛ - {‖ x ‖}_{2}^{2} )} x$$

$$∇ {g}_{2} ( x ) = \frac{2}{t ( N + ɛ - {‖ x ‖}_{2}^{2} )} x$$

$$∇ {g}_{m + 2} ( x ) = \frac{1}{t ( {e}_{m}^{T} x - δ )} {e}_{m}$$

### Hessians:

$${∇}^{2} {f}_{0} ( x ) = {D}^{H} {W}^{H} W D + {( {D}^{H} {W}^{H} W D )}^{T}$$

$${∇}^{2} {g}_{1} ( x ) = \frac{2}{{t ( N - ɛ - {‖ x ‖}_{2}^{2} )}^{2}} ( 2 x {x}^{T} + ( N - ɛ - {‖ x ‖}_{2}^{2} ) I )$$

$${∇}^{2} {g}_{2} ( x ) = \frac{2}{{t ( N - ɛ - {‖ x ‖}_{2}^{2} )}^{2}} ( 2 x {x}^{T} + ( N + ɛ - {‖ x ‖}_{2}^{2} ) I )$$

$${∇}^{2} {g}_{m + 2} ( x ) = \frac{1}{{t ( {e}_{m}^{T} x - δ )}^{2}} {e}_{m} {e}_{m}^{T}$$

where I is the N×N identity matrix. Armed with these derivatives and given a strictly feasible starting vector x (i.e. a vector that satisfies the original constraints on the problem), the barrier method (as shown in Table 1) can be implemented to find an optimal vector x* that minimises the cost function described above subject to the aforementioned constraints.

Reducing the complexity of the numerical algorithm (claims):

From Table 1, it is observed that for each iteration of Newton's method, the inverse of the Hessian of the composite objective function must be available in order to compute Δx. This Hessian is given by

$${∇}^{2} f ( x ) = t {∇}^{2} {f}_{0} ( x ) + t {\sum }_{k} {∇}^{2} {g}_{k} ( x ) .$$

It will be noted that the inverse of this Hessian matrix is a function of the optimisation variable x as well as of the diagonal data matrix D. Consequently, as either of these quantities changes, the inverse of the Hessian must be recomputed, which can lead to a large computational overhead. Fortunately, steps can be taken to reduce this overhead. For example, the well-known quasi-Newton method could be used in place of the standard Newton method. In this technique, the inverse of the Hessian matrix is not computed directly, but an approximation of the matrix is built over a number of iterations. Consequently, this method works well in some simple cases, but a large computational overhead is generally still required in order to build an accurate representation of the inverse of the Hessian matrix. Alternatively, a modified Newton method can be used. This technique is identical to the standard Newton method, but the inverse of the Hessian matrix is only computed during the first iteration. This matrix is then used for all future updates to the step direction Δx. While this method works well for many cases of interest, it still involves the computation of a (possibly large) matrix inverse at regular intervals.

Clearly, it is not possible to reduce the complexity of the numerical interference avoidance technique (and algorithms of a similar structure) discussed above through the direct application of standard methods. However, the structure of the Hessian matrix can be exploited in conjunction with these methods to reduce the complexity of the Newton algorithm. This reduction can be achieved by making approximations to the Hessian matrix and by constraining the data to be drawn from a real-valued constellation such as BPSK.

First, the Hessians corresponding to the box inequality constraints are considered. In order to simplify these expressions, it is assumed that ∥x∥₂²=N, which results in the modified expressions:

$${∇}^{2} {\tilde{g}}_{1} ( x ) = \frac{2}{t {ɛ}^{2}} ( 2 x {x}^{T} - ɛ {I}_{N} )$$

$$and$$

$${∇}^{2} {\tilde{g}}_{2} ( x ) = \frac{2}{t {ɛ}^{2}} ( 2 x {x}^{T} + ɛ {I}_{N} ) .$$

### Noting that

$$Λ ( x ) := t {\sum }_{k} {∇}^{2} {g}_{m + 2} ( x ) = diag \{ \frac{1}{{( {x}_{0} - δ )}^{2}} , … , \frac{1}{{( {x}_{N - 1} - δ )}^{2}} \} ,$$

an approximation to the Hessian matrix can be formulated as

$${∇}^{2} f ( x ) \approx t ( {D}^{H} {W}^{H} W D + {( {D}^{H} {W}^{H} W D )}^{T} ) + \frac{8}{{ɛ}^{2}} x {x}^{T} + Λ ( x )$$

Now, making the assumption that the data is drawn from a real-valued constellation, such as BPSK, it is evident that D^{H}=D^{T}=D and the approximate Hessian matrix can therefore be rewritten as

$${∇}^{2} f ( x ) \approx t D Ω D + \frac{8}{{ɛ}^{2}} x {x}^{T} + Λ ( x )$$

$$where$$

$$Ω := {W}^{H} W + {( {W}^{H} W )}^{T} .$$

It will be noted that the first term on the right-hand side of the approximate Hessian matrix above is not a function of the optimisation vector x, the second term is a rank-one update, and the third term is a diagonal matrix that is a function of x. Rank-one updates to the inverse of a matrix are easily computed via the matrix inversion lemma. Thus, the inverse of the approximated Hessian matrix can be computed efficiently as long as the inverse of the matrix

B(x)≈tDΩD+Λ(x)

can be computed efficiently.

In order to minimise the complexity of the numerical algorithm, it is beneficial to further approximate B(x)≈\tilde{B}, which is not a function of the optimisation variable x. By making this approximation, the inverse of \tilde{B} must be computed at most once per transmitted data block instead of with each update of x, which occurs multiple times with each transmitted data block. This approximation is performed by replacing Λ(x) with \tilde{Λ}=tγI where I is the identity matrix of the appropriate size and γ>0 is a design parameter. The resulting approximate Hessian matrix is given by

∇²\tilde{f}(y)=\tilde{B}+yy^{T}=t(DΩD+γI)+yy^{T}

where

$$y := \frac{2 \sqrt{2}}{ɛ} x$$

and the inverse of this Hessian matrix can be computed using the matrix inversion lemma, resulting in the expression

$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} y {y}^{T} {\tilde{B}}^{- 1}$$

which requires O(4N²) complex multiplications if \tilde{B}⁻¹ is known.

In order to compute \tilde{B}⁻¹ efficiently, it is observed that

$$\begin{matrix}{\tilde{B}}^{- 1} = \frac{1}{t} {( D Ω D + γ I )}^{- 1} \\ = \frac{1}{t} {( D ( Ω + γ {D}^{- 2} ) D )}^{- 1}\end{matrix}$$

$$But$$

$${D}^{- 2} = {D}^{- 1} {D}^{- 1} = \frac{1}{{σ}_{d}^{2}} I$$

is a constant, where σ_{d}² is the variance of the zero-mean data signal. Consequently,

$${\tilde{B}}^{- 1} = \frac{1}{t} {{D}^{- 1} ( Ω + \frac{γ}{{σ}_{d}^{2}} I )}^{- 1} {D}^{- 1}$$

which can be partly precomputed for given interference bands, leaving only the pre- and post-multiplication by the diagonal matrix D⁻¹ and scaling by 1/t for each outer iteration of the barrier method. Fixing t at some predetermined value t=τ can reduce the complexity even further, resulting in the computation of \tilde{B}⁻¹ once per data block. By utilising the approximation and the update of the inverse Hessian matrix, the modified Newton method discussed above can be implemented with good results (i.e. the approximate inverse Hessian matrix can be computed only once at the start of the Newton algorithm). This modified algorithm is summarised in Table 2.

TABLE 2
Reduced-complexity numerical interference avoidance algorithm.

given strictly feasible x,
t > 0, τ > 0, γ > 0, μ > 1, tolerance εₒ > 0, tolerance εᵢ > 0
$initialise {\tilde{B}}^{- 1} = \frac{1}{τ} {{D}^{- 1} ( Ω + \frac{γ}{{σ}_{d}^{2}} I )}^{- 1} {D}^{- 1}$
repeat

| 1. | Newtons's method (x, εᵢ > 0) |
|---|---|
| | $a . Compute {∇}^{2} {\tilde{f} ( x )}^{- 1} = {\tilde{B}}^{- 1} - \frac{1}{\frac{{ɛ}^{2}}{8} + {x}^{T} {\tilde{B}}^{- 1} x} {\tilde{B}}^{- 1} {xx}^{T} {\tilde{B}}^{- 1}$ |
| | b. Δx = −∇² f(x)⁻¹ ∇f(x) |
| | λ² = −∇f(x)^{T} Δx |
| | c. quit if λ²/2 < εᵢ |
| | return x* := x |
| | d. Line search (determine β) |
| | e. x := x + βΔx |
| 2. | x := x* |
| 3. | quit if p/t < ε₀ |
| 4. | t := μt |

The skilled person will recognise that the approximation steps discussed above can be applied to any numerical optimisation algorithm of the form presented here to reduce its complexity from cubic to quadratic in N. This reduction primarily results from the fact that the inverse of the Hessian matrix is no longer computed directly.

Application of the reduced-complexity algorithm to larger constellations will now be described.

As previously mentioned, this technique only supports the transmission of signals drawn from real-valued constellations. However, multiple data signals can be treated as ‘layers’, and these signals can be superimposed to form a composite signal. Of course, one must be careful when designing the transmitted signal in this way since the energy of the composite signal may be greater than the sum of the energies of the constituent signals. A simple example of this approach arises when the composite signal is composed of two layers. In this case, one layer can be designed as the in-phase component and the other layer can be designed as the quadrature component, thus resulting in a QPSK transmission.

As observed in Table 2, the reduced-complexity Newton/barrier method relies on several parameters to perform optimisation. These parameters—specifically, μ, ε₀, εᵢ, τ, γ, and an initial value of t—are typically design parameters and can take on a range of values. Specific values that work well for most practical IA cases of interest (e.g. nulling 9 upsampled tones out of a total of 512 upsampled tones) have been found to be

μ=20
ε₀=εᵢ=0.1
τ=100
initial value of t=t⁽⁰⁾=(N+2)/∥WDx⁽⁰⁾∥₂²
where x⁽⁰⁾ is the feasible starting vector.

Furthermore, it is beneficial to choose a parameter δ that provides sufficient flexibility for deep frequency notch creation while facilitating robust blind detection at the receiver. Obviously, as δ decreases, some data symbols may not be transmitted with much power, thus leading to a lower signal-to-noise ratio (SNR) for those symbols at the receiver. Consequently, the overall performance of the system suffers. This problem can be mitigated somewhat through the use of suitable forward error correcting codes such as power convolutional codes, turbo codes, or low-density parity check codes. However, there will always be a small degradation in performance due to the parameter δ.

In practice, a value of δ=1/√2 only allows a reduction in transmit power for a given data symbol by ½. This reduction is sufficiently minor to allow the error correcting code that is employed to mitigate the negative effects on SNR. However, the depth of the frequency notch may suffer if the notch is on the order of several upsampled tones wide. A value of δ=½, while causing greater reductions in SNR, provides sufficient flexibility to the optimisation algorithm to achieve frequency notches on the order of −30 to −60 dB in depth for a width of several upsampled tones. The performance of a system with this value of 6 is not significantly degraded as shown in FIG. 9. Indeed, as shown in this example, the performance loss relative to a reference system where IA is not implemented (or needed) is only 1-2 dB, whereas the degradation in performance for a single-carrier system using AIC is much greater.

It should be noted that the reduction in SNR caused by δ is localised to individual data symbols. Indeed, the average SNR remains the same as for an unconstraint system due to the power constraint that is employed. Due to this constraint, some data symbols may actually benefit from an increase in SNR so that the total average power in a transmitted block is normalised.

A feasible starting vector x⁽⁰⁾ needs to be selected, and very simple starting vector x⁽⁰⁾ that satisfies the constraints is simple a length-N vector of ones. Other starting vectors can be used, and do not seem to affect the performance or rate-of-convergence of the algorithm.

Line search is then initiated in accordance with Table 2, to find β. The line search is part of the standard barrier method as discussed in Boyd, S. and Vandenberghe, L. Convex Optimization (Cambridge University Press. 2004). Examples of this technique include the ‘exact’ line search and the ‘backtracking’ line search. Any standard line search can be used to obtain the scaling value β.

An optional approach to speeding up the algorithm will now be described. A ‘minimum notch depth’ can be defined to aid the execution time of the IA algorithm when it is implemented numerically (e.g. using the barrier method). In this case, a ‘null depth condition’ (NDC) is checked with each update of the vector x. If the NDC is satisfied (i.e. max |[WDx]ₘ|²≦η where η is the desired null depth), the algorithm exits and the current x is taken to be the ‘optimal’ x. Empirical studies have shown that this technique can reduce the computation time by one half.

A ‘fail mode’ can be optionally implemented to ensure signals without sufficient nulls are not transmitted. For example, a fail mode may be triggered after a predetermined number of iterations of the numerical optimisation algorithm if convergence to an optimal x has not been achieved. Also, a fail mode may be triggered if an NDC is not satisfied. This is applicable to analytical and numerical implementations of cost/utility function minimisation/maximisation. In the event that a fail mode is triggered for an IA algorithm, the transmitter can apply any number of additional measures to ensure the energy transmitted on the ‘interference tones’ does not exceed a predetermined threshold:
1. TPC can be implemented for the block that has failed;
2. AIC can be implemented for the block that has failed;
3. Frequency notching can be implemented through other means as well for the block that has failed;
4. The transmitter can reorder or puncture some of the symbols in the transmitted block in a pseudorandom manner known to the receiver and recompute the vector x in the hope that a fail mode is not triggered for this new block;
5. The transmitter can refrain from transmitting the offending block.

A qualitative description of the application of the reduced-complexity barrier method to dynamically optimise a block of data for IA now follows.
1. The constraints of the problem are chosen.
2. The parameters t⁽⁰⁾, μ and tolerances of the algorithm ε₀, εᵢ are chosen.
3. A starting vector x that satisfies the constraints is chosen (e.g. the vector of ones).
4. Reduced-complexity Newton's method is run.
5. With each iteration of Newton's method, an NDC is checked.
   a. If the NDC is not met, skip to step c)
   b. If the NDC is met, the current vector x is taken to be optimal and the algorithm exits.
   c. If the inner tolerance εᵢ is met (cf. Table 2), the current optimal vector x is the output of Newton's method (go to step 6)).
   d. If the inner tolerance is not met, go to step 5).
6. Check outer tolerance.
   a. If outer tolerance ε₀ is met or the NDC is met, quit iterations and current optimal vector is the final optimal vector.
   b. Else if a fail mode is triggered, implement one of the fail mode options described above.
   c. Else, increase t and go to step 4) where starting vector is current optimal vector.

The envelope can therefore be applied to a subset of data symbols. It will be understood that the envelope function is not limited to being applied to all data symbols in a block. Indeed, any subset of symbols can be perturbed by the envelope function. By reducing the number of affected symbols, the SNR degradation (or amplification) is limited to only those symbols, which can improve performance. Since fewer degrees of freedom are allocated to the optimisation algorithm in this case, this approach should only be used when the width of the desired notch is relatively small (on the order of a few upsampled tones).

As described above, the present invention aims to overcome the drawbacks of the state of the art.

In the context of TPC, the present invention aims to allow a broadband user to continue to transmit at full power without significantly affecting other (narrowband) users' transmissions. Systems that implement TPC to perform IA cannot, by definition, transmit at full power; thus a loss in information rate is unavoidable.

In relation to frequency notching, the present invention aims to dynamically provide accurate notches with a tuneable depth (on the order of −30 to −60 dB). Conventional frequency notching can realistically provide notches on the order of approximately −9 dB.

Active interference cancellation (AIC) works well in multi-carrier systems with a variable transmission length. However, when applied to fixed transmission length systems and (especially) single-carrier systems, the performance of a system using this technique degrades. As shown in FIG. 9, single-carrier systems with fixed transmission length do not incur a significant performance loss when a specific embodiment of the present invention is implemented.

Additional constraints can be added to the optimisation problem to aid practical systems. For example, a peak-to-average power ratio (PAPR) constraint can be placed on the transmitted signal so that the linearity requirements and/or backoff of the power amplifiers can be relaxed.

Furthermore, the tuneability (both in terms of notch depth and algorithmic complexity) allows this technique to be utilised by a broad range of wireless devices, including base stations and mobile terminals.

Whereas the invention has been described in the context of a time-domain operation, it will be understood that the complexity reduction afforded thereby could also be applied to a frequency domain situation. “Subcarrier Weighting: A Method for Sidelobe Suppression in OFDM Systems” (Ivan Cosovic, Sinja Brandes, and Michael Schnell, IEEE Communications Letters, Vol. 10, No. 6, June 2006) describes an approach to suppression of sidelobes that are often encountered in OFDM transmission. In that paper, an optimisation algorithm is employed to minimise the sidelobes of the transmission signal. The optimisation algorithm introduces computational complexity, reduction of which the paper does not address.

Essentially, the paper is concerned with out of band phenomena, and the present invention also lends itself to a reduced complexity approach for doing so. The skilled reader will understand that the process set out above in relation to optimising the time domain envelope function, in order to suppress particular parts of a wideband spectrum, can equally apply to the suppression of out of band sidelobes.

In such a case, it will be appreciated by the skilled reader that the operation will be conducted in a block preceding the “OFDM Only” block in FIG. 5. In such an example, the presence of the envelope function block following the OFDM Only block is not essential, but could be provided as well if there is a need for both sidelobe suppression and spectral shaping in the same device.

No doubt many other effective alternatives will occur to the skilled person. It will be understood that the invention is not limited to the described embodiments and encompasses modifications apparent to those skilled in the art lying within the scope of the claims appended hereto.

1. A method of shaping the spectrum of a signal in a block transmission system by applying an envelope function, the method comprising:
optimising the envelope function under one or more constraints selected from a set of predetermined constraints; and
applying the optimised envelope function to the signal,
wherein the step of optimising the envelope function comprises employing a quasi-Newton optimisation involving determination of an approximate inverse ∇²\tilde{f}(y)⁻¹ of an objective Hessian matrix of a cost function y of the optimisation, said approximate inverse comprising
$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} y {y}^{T} {\tilde{B}}^{- 1}$$
$$wherein$$
$${\tilde{B}}^{- 1} = \frac{1}{t} {{D}^{- 1} ( Ω + \frac{γ}{{σ}_{d}^{2}} I )}^{- 1} {D}^{- 1} ,$$
D being a diagonal data matrix, and Ω:=W^{H}W+(W^{H}W)^{T}, W being a domain transform matrix, y being a design factor, and σ_{d}² being the variance of the zero mean data signal.

2. The method of claim 1 wherein the method is directed to shaping in the time domain, the envelope function comprises a time domain envelope function, and W is a a Fourier transform matrix.

3. The method of claim 2 in which the optimised time-domain envelope function is applied in a dynamic manner.

4. The method of claim 2 in which the time-domain envelope function is optimised in a dynamic manner.

5. The method of claim 4 in which the dynamic optimisation is applied to each symbol transmission.

6. The method of claim 2 in which the set of constraints is chosen in order to establish interference avoidance, a cost function, or a utility function.

7. The method claim 2 in which the envelope function is applied to all time-domain samples in a data block.

8. The method of claim 2 in which the envelope function is applied to all time-domain samples in a subset of a data block.

9. The method of claim 2 in which the signal transmission system is a single-carrier, a multi-carrier, or an OFDM block transmission system.

10. The method of claim 2 in which the predetermined constrains comprise signal transmission characteristics, selected from among the group comprising PAPR, total power, and dynamic range.

11. The method of claim 1 in which the criterion selected is interference avoidance.

12. The method of claim 1 in which the dynamic optimisation of the envelope function is performed numerically in an iterative manner.

13. A computer program product stored in a computer readable medium, for causing a computer when executing the computer program product to configure a signal transmission system, comprising:
first program code for optimising the envelope function under one or more constraints selected from a set of predetermined constraints; and
second program code for applying the optimised envelope function to the signal, wherein the step of optimising the envelope function comprises employing a quasi-Newton optimisation involving determination of an appropriate inverse ∇²\tilde{f}(y)⁻¹ of an objective Hessian matrix of a cost function y of the optimisation, said approximate inverse comprising
$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} y {y}^{T} {\tilde{B}}^{- 1}$$
$$wherein$$
$${\tilde{B}}^{- 1} = \frac{1}{t} {{D}^{- 1} ( Ω + \frac{γ}{{σ}_{d}^{2}} I )}^{- 1} {D}^{- 1} ,$$
D being a diagonal data matrix, and Ω:=W^{H}W+(W^{H}W)^{T}, W being a domain transform matrix, γ being a design factor, and σ_{d}² being the variance of the zero mean data signal.

14. A receiver configured to receive a spectrum-shaped signal, said signal shaped by:
optimising the envelope function under one or more constraints selected from a set of predetermined constraints; and
applying the optimised envelope function to the signal, wherein the step of optimising the envelope function comprises employing a quasi-Newton optimisation involving determination of an appropriate inverse ∇²\tilde{f}(y)⁻¹ of an objective Hessian matrix of a cost function y of the optimisation, said approximate inverse comprising
$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} y {y}^{T} {\tilde{B}}^{- 1}$$
$$wherein$$
$${\tilde{B}}^{- 1} = \frac{1}{t} {{D}^{- 1} ( Ω + \frac{γ}{{σ}_{d}^{2}} I )}^{- 1} {D}^{- 1} ,$$
D being a diagonal data matrix,
and Ω:=+W^{H}W+(W^{H}W)^{T}, W being a domain transform matrix, γ being a design factor, and σ_{d}² being the variance of the zero mean data signal.

15. A signal transmission system comprising means for shaping the spectrum of a signal in a block transmission system by applying an envelope function, the shaping means comprising:
means for optimising the envelope function under one or more constraints selected from a set of predetermined constraints; and
means for applying the optimised envelope function to the signal, wherein the step of optimising the envelope function comprises employing a quasi-Newton optimisation involving determination of an appropriate inverse ∇²\tilde{f}(y)⁻¹ of an objective Hessian matrix of a cost function y of the optimisation, said approximate inverse comprising
$${∇}^{2} {\tilde{f} ( y )}^{- 1} = {\tilde{B}}^{- 1} - \frac{1}{1 + {y}^{T} {\tilde{B}}^{- 1} y} {\tilde{B}}^{- 1} y {y}^{T} {\tilde{B}}^{- 1}$$
$$wherein$$
$${\tilde{B}}^{- 1} = \frac{1}{t} {{D}^{- 1} ( Ω + \frac{γ}{{σ}_{d}^{2}} I )}^{- 1} {D}^{- 1} ,$$
D being a diagonal data matrix, and Ω:=W^{H}W+(W^{H}W)^{T}, W being a domain transform matrix, γ being a design factor, and σ_{d}² being the variance of the zero mean data signal.
